(19) United States
(12) Patent Application Publication
(10) Pub. No.: US 2026/0106169 A1
(43) Pub. Date: Apr. 16, 2026

(54) ELECTRODE AND METHOD FOR MANUFACTURING SAME

(71) Applicant: SAMSUNG SDI CO., LTD., Yongin-si (KR)

(72) Inventors: Jungah YOON, Yongin-si (KR); Taesu JEONG, Yongin-si (KR); Eunhyeok SHIN, Yongin-si (KR)

(21) Appl. No.: 19/331,233

(22) Filed: Sep. 17, 2025

(30) Foreign Application Priority Data
Oct. 16, 2024 (KR) 10-2024-0141296

(51) Int. Cl. H01M 4/66; H01M 4/04

(52) U.S. Cl. CPC H01M 4/667; H01M 4/0471; H01M 4/661; H01M 4/668

(57) ABSTRACT

An electrode includes a composite substrate including a first metal layer, a polymer layer, and a second metal layer, which are sequentially stacked, a first substrate tab coupled with the first metal layer, a second substrate tab coupled with the second metal layer, and a sealing layer between the composite substrate and each of the first substrate tab and the second substrate tab.

### CROSS-REFERENCE TO RELATED APPLICATION

This application claims priority under 35 U.S.C. § 119 to Korean Patent Application No. 10-2024-0141296, filed in the Korean Intellectual Property Office on Oct. 16, 2024, the entire contents of which are hereby incorporated by reference.

### BACKGROUND

### 1. Field

The present disclosure relates to an electrode and a method for manufacturing an electrode.

### 2. Description of the Related Art

Unlike primary batteries that are not designed to be (re)charged, secondary (or rechargeable) batteries are batteries that are designed to be discharged and recharged.

Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

The above information disclosed in this Background section is for enhancement of understanding of the background of the present disclosure, and therefore, it may contain information that does not constitute related (or prior) art.

### SUMMARY

An electrode according to an embodiment of the present disclosure includes a composite substrate having a first metal layer, a polymer layer, and a second metal layer, which are sequentially stacked, a first substrate tab coupled with the first metal layer, and a second substrate tab coupled with the second metal layer. Sealing layers may be disposed between the composite substrate and the first substrate tab and between the composite substrate and the second substrate tab.

According to an embodiment, the sealing layers may include a first sealing layer formed on a surface of the first substrate tab facing the first metal layer, and a second sealing layer formed on a surface of the second substrate tab facing the second metal layer.

According to an embodiment, the sealing layer may include a third sealing layer formed on the first metal layer and a fourth sealing layer formed on the second metal layer.

According to an embodiment, the third sealing layer may come into contact with the first sealing layer, and the fourth sealing layer may come into contact with the second sealing layer.

According to an embodiment, thicknesses of the first sealing layer and the second sealing layer may be 1 μm to 5 μm.

According to an embodiment, the first sealing layer and the second sealing layer may contain at least one of cast polypropylene (CPP) or polypropylene (PP).

According to an embodiment, the first substrate tab may be welded to the first metal layer, the second substrate tab may be welded to the second metal layer, and the first substrate tab, the composite substrate, and the second substrate tab may be coupled with each other by a welding portion.

According to an embodiment, the welding portion may be formed at a position separated from a mixture portion formed on the composite substrate, and is formed to extend in a longitudinal direction of the electrode.

According to an embodiment, the welding portion may be formed at corner portions of the first metal layer and the second metal layer.

According to an embodiment, the welding portion may be formed to be separated from the corner portions of the first metal layer and the second metal layer.

According to an embodiment, the sealing layer may be melted to form a fixing portion that fixes the first substrate tab and the second substrate tab.

According to an embodiment, the fixing portion may be formed by melting and connecting the sealing layer disposed between the composite substrate and the first substrate tab and the sealing layer disposed between the composite substrate and the second substrate tab.

According to an embodiment, the fixing portion may be formed separately by melting each of the sealing layer disposed between the composite substrate and the first substrate tab and the sealing layer disposed between the composite substrate and the second substrate tab.

According to an embodiment, the electrode may include a body portion including a mixture portion, an uncoated portion, and the welding portion, and a tab portion protruding from the body portion and including the welding portion and the fixing portion.

According to an embodiment, a width of the fixing portion may be smaller than a width of the tab portion.

According to an embodiment, the width of the fixing portion may be 40% to 60% of the width of the tab portion.

A method for manufacturing an electrode according to an embodiment of the present disclosure includes preparing a composite substrate including a polymer layer and metal layers formed on both surfaces of the polymer layer, welding the metal layers and substrate tabs with sealing layers interposed therebetween, melting and sealing the sealing layers by using a sealer, and cutting the composite substrate.

According to an embodiment, the welding of the metal layers and the substrate tabs with the sealing layers interposed therebetween may include disposing the substrate tabs on the metal layers with the sealing layers interposed therebetween, and welding the metal layers and the substrate tabs by using a welding horn.

According to an embodiment, the melting and sealing of the sealing layers by using the sealer may include melting the sealing layers to form a fixing portion that fixes the substrate tabs, and the fixing portion may be disposed to be separated along a longitudinal direction of a welding portion.

According to an embodiment, the cutting of the composite substrate may include punching so as to include the fixing portion.

### BRIEF DESCRIPTION OF DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings:

FIG. 1 is a sectional view illustrating an example of an electrode according to an embodiment of the present disclosure;

FIG. 2 is a sectional view illustrating an example of a composite substrate according to an embodiment of the present disclosure;

FIG. 3 is a sectional view illustrating an example of a substrate tab including a sealing layer according to an embodiment of the present disclosure;

FIG. 4 is a sectional view illustrating an example of a composite substrate having a mixture portion according to an embodiment of the present disclosure;

FIG. 5 is a plan view illustrating an example of the composite substrate having the mixture portion according to an embodiment of the present disclosure;

FIG. 6 is a plan view illustrating an upper part of the composite substrate cut along X-X′ line of FIG. 5;

FIG. 7 is a plan view illustrating an example of a composite substrate having a substrate tab welded thereto according to an embodiment of the present disclosure;

FIG. 8 is a sectional view illustrating an example of a composite substrate having a substrate tab welded thereto according to an embodiment of the present disclosure;

FIG. 9 is a diagram illustrating an example in which a substrate tab is sealed by using a sealer according to an embodiment of the present disclosure;

FIG. 10 is a plan view illustrating an example of an electrode including a fixing portion according to an embodiment of the present disclosure;

FIG. 11 is a plan view illustrating an example of a punched electrode according to an embodiment of the present disclosure;

FIG. 12 is a sectional view illustrating an example of a composite substrate including a sealing layer according to an embodiment of the present disclosure;

FIG. 13 is a sectional view illustrating an example of a composite substrate having a substrate tab welded thereto according to an embodiment of the present disclosure;

FIG. 14 is a diagram illustrating an example in which a substrate tab is sealed by using a sealer according to an embodiment of the present disclosure;

FIG. 15 is a plan view illustrating an example of an electrode including a fixing portion according to an embodiment of the present disclosure;

FIG. 16 is a plan view illustrating an example of a punched electrode according to an embodiment of the present disclosure;

FIG. 17 is a flowchart of a method for manufacturing an electrode according to an embodiment of the present disclosure; and

FIG. 18 is a diagram for describing a method for manufacturing an electrode according to an embodiment of the present disclosure.

### DETAILED DESCRIPTION

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain his/her invention in the best way.

The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

In the present disclosure, layers and regions illustrated in the drawings may be exaggerated in size and relative size for the clarity of the description. For example, the sizes illustrated in the drawings are merely for the sake of convenience of understanding, and are not limited thereto. Throughout the specification, the same reference numerals denote the same components.

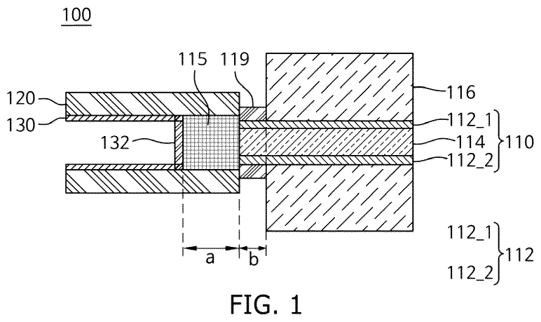

FIG. 1 is a sectional view illustrating an example of an electrode according to an embodiment of the present disclosure.

Referring to FIG. 1, an electrode 100 may include a composite substrate 110, a mixture portion 116, on which an active material is applied, on the composite substrate 110, and a substrate tab 120 connected to the composite substrate 110. The electrode 100 may include an insulating layer 119 formed on a surface of an uncoated portion of the composite substrate 110. The electrode 100 may include a sealing layer 130 formed on a surface of the substrate tab 120.

According to an embodiment, the composite substrate 110 may include metal layers 112 on opposite surfaces of a polymer layer 114. For example, referring to FIG. 1, the metal layers 112 may include a first metal layer 112_1 and a second metal layer 112_2, such that the first metal layer 112_1, the polymer layer 114, and the second metal layer 112_2 may be sequentially stacked. The polymer layer 114 may be, e.g., polyethylene terephthalate (PET). Each of the metal layers 112 may include, e.g., aluminum (Al) or copper (Cu).

According to an embodiment, the mixture portion 116 (e.g., a coating layer defining the coated portion of the composite substrate 110) may be deposited on the composite substrate 110 (e.g., on a first portion of each of the metal layers 112), while a second portion of each of the metal layer 112 may remain exposed (i.e., without the mixture portion 116) to define an uncoated portion of the composite substrate 110. The insulating layer 119 may be coated on the uncoated portion of the composite substrate 110 to which an active material is not applied. The insulating layer 119 may include, e.g., polyimide (PI), ceramic, and the like. Polyimide (PI) may be a material based on a polymer material. Ceramic may be a material based on a non-metallic material, may have high chemical stability to protect the surface of the composite substrate 110 and may prevent a short circuit due to excellent electrical insulation properties. However, the material of the insulating layer 119 may vary.

According to an embodiment, the substrate tab 120 may include the sealing layer 130 formed on the surface of the substrate tab 120. The sealing layer 130 may be formed on the surface of the substrate tab 120 facing the metal layer 112 and may be disposed between the substrate tab 120 and the composite substrate 110. The sealing layer 130 may include a fixing portion 132 formed by being melted and connected to each other. In the present disclosure, the disposition of the sealing layer 130 between the substrate tab 120 and the composite substrate 110 may be interpreted to encompass various dispositions in which the sealing layer comes into contact with both the substrate tab and the composite substrate in order to enhance fixing strength between the substrate tab and the composite substrate.

According to an embodiment, the substrate tab 120 may be coupled with the composite substrate 110. The substrate tab 120 may be disposed on the uncoated portion of the composite substrate 110, and a contact surface of the metal layer 112 on the surface of the composite substrate 110 and the substrate tab 120 may be coupled by welding to form a welding portion 115.

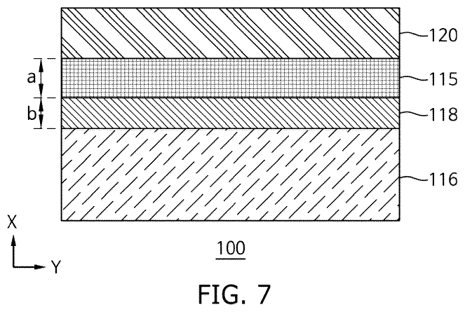

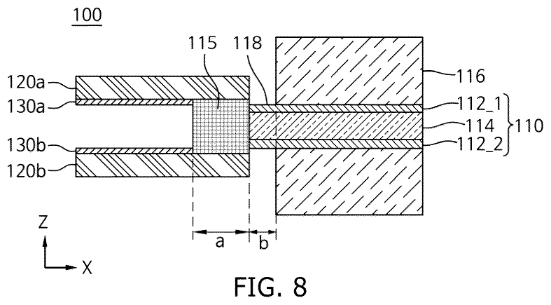

According to an embodiment, the welding portion 115 may be formed to be separated from a boundary line between the mixture portion 116 and the uncoated portion 118 (FIG. 8) by a predetermined distance b (FIG. 7). The welding portion 115 may be formed at a predetermined distance a from a position separated from the mixture portion 116 by the predetermined distance b to an end of the composite substrate 110.

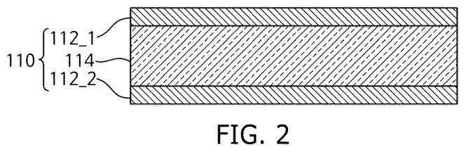

FIG. 2 is a sectional view illustrating an example of the composite substrate 110 according to an embodiment of the present disclosure.

Referring to FIG. 2, the composite substrate 110 may include the first metal layer 112_1, the polymer layer 114, and the second metal layer 112_2 that are sequentially stacked. The composite substrate 110 may further include a surface processing layer and an adhesive layer between the polymer layer 114 and each of the first metal layer 112_1 and the second metal layer 112_2. As a result, the first metal layer 112_1, the polymer layer 114, and the second metal layer 112_2 may be coupled with each other to form the composite substrate 110.

According to an embodiment, each of the first metal layer 112_1 and the second metal layer 112_2 may be coated with a metal material such as copper (Cu), a copper alloy, nickel (Ni), or a nickel alloy on the polymer layer 114, or may be coated with a metal material such as aluminum (Al) or an aluminum alloy. The first metal layer 112_1 and the second metal layer 112_2 may be made of an identical metal material and may function as a positive electrode or a negative electrode.

According to an embodiment, the polymer layer 114 may contain a polymer material.

For example, the polymer layer 114 may contain a polyethylene terephthalate (PET) resin. The material of the polymer layer 114 may include, e.g., a polyester resin such as polytrimethylene terephthalate (PTT), polybutylene terephthalate (PBT), or polyethylene naphthalate (PEN). As described above, the polymer layer 114 including the polymer resin may be used, and thus, flexibility and lightness of the first electrode 100 may be secured.

According to an embodiment, a thickness of each of the first metal layer 112_1 and the second metal layer 112_2 may be smaller than a thickness of the polymer layer 114. When the first metal layer 112_1 and the second metal layer 112_2 contain aluminum (Al), a ratio of the thickness of each of the first metal layer 112_1 and the second metal layer 112_2 to the thickness of the polymer layer 114 may be 1:8 to 1:6. When the first metal layer 112_1 and the second metal layer 112_2 contain copper (Cu), the ratio of the thickness of each of the first metal layer 112_1 and the second metal layer 112_2 to the thickness of the polymer layer 114 may be 2:9. However, the ratio of the thickness of each of the first metal layer 112_1 and the second metal layer 112_2 to the thickness of the polymer layer 114 may vary.

According to an embodiment, the first metal layer 112_1 and the second metal layer 112_2 may be coated on both surfaces (e.g., opposite surfaces) of the polymer layer 114, respectively. The metal layers 112 may be coupled with the substrate tab 120, and may be electrically connected to an outside. As a result, a substantially identical electrical conductivity and battery performance may be secured as compared to an electrode made of a single metal material.

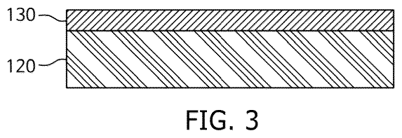

FIG. 3 is a sectional view illustrating an example of the substrate tab 120 including the sealing layer 130 according to an embodiment of the present disclosure.

Referring to FIG. 3, the substrate tab 120 may include the sealing layer 130 formed on the surface of the substrate tab 120.

According to an embodiment, the substrate tab 120 may be made of a metal foil such as copper (Cu), a copper alloy, nickel (Ni), a nickel alloy, or may include a metal foil such as aluminum (Al) or an aluminum alloy. The material of the substrate tab 120 may vary, and may be made of a metal material with excellent electrical conductivity. The substrate tab 120 may contain a material identical to that of the first metal layer 112_1 and the second metal layer 112_2.

A thickness of the sealing layer 130 may be set in consideration of sealing strength. As the thickness of the sealing layer 130 increases, the sealing strength may increase.

However, because energy density of a secondary battery decreases, it is necessary to appropriately set the thickness of the sealing layer. The energy density of the secondary battery may mean the amount of energy that may be stored per unit volume. According to an embodiment, the thickness of the sealing layer 130 may be set to 1 μm to 5 μm to secure sufficient sealing strength of 1 kgf or more. As a result, appropriate sealing strength may be secured, and the energy density of the secondary battery may be prevented from decreasing.

According to an embodiment, the material of the sealing layer 130 may contain any one of cast polypropylene (CPP) and polypropylene (PP). Because cast polypropylene (CPP) and polypropylene (PP) are materials based on polymer substances and have high thermoplasticity, cast polypropylene (CPP) and polypropylene (PP) may be melted by a sealer and used in a sealing process. Solidified cast polypropylene (CPP) and polypropylene (PP) may increase the fixing strength of the substrate tab 120 due to excellent mechanical properties. However, the material of the sealing layer 130 may vary.

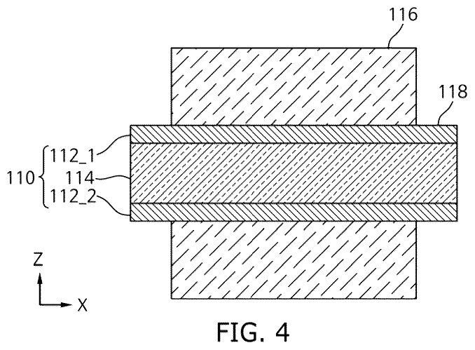

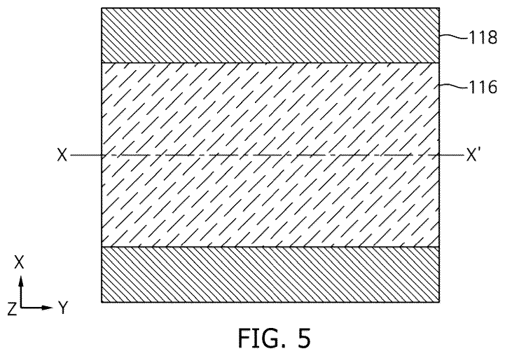

FIG. 4 is a sectional view illustrating an example of the composite substrate 110 having the mixture portion 116 disposed thereon according to an embodiment of the present disclosure, and FIG. 5 is a plan view illustrating an example of the composite substrate 110 having the mixture portion 116 disposed thereon according to an embodiment of the present disclosure.

Referring to FIGS. 4 and 5, the electrode 100 may include the composite substrate 110, the mixture portion 116, on which the active material is applied, on the composite substrate 110, and the uncoated portion 118 on which the composite substrate 110 is exposed. That is, the uncoated portion 118 refers to a portion of the composite substrate 110 that is not coated with the mixture portion 116.

According to an embodiment, the mixture portion 116 may be disposed in a center of a width direction of the composite substrate 110. The uncoated portion 118, in which the composite substrate 110 is exposed, may be formed because the active material is not applied on at least one end with respect to the width direction of the composite substrate 110.

According to an embodiment, when the electrode 100 is formed as a positive electrode, the mixture portion 116 may contain a positive electrode active material.

The positive electrode active material may include a compound (lithiated intercalation compound) that is capable of intercalating and deintercalating lithium. Specifically, at least one of a composite oxide of lithium and a metal selected from cobalt, manganese, nickel, and combinations thereof may be used.

The composite oxide may be a lithium transition metal composite oxide. Specific examples of the composite oxide may include lithium nickel oxide, lithium cobalt oxide, lithium manganese oxide, lithium iron phosphate compound, cobalt-free nickel-manganese oxide, or a combination thereof.

As an example, the following compounds represented by any one of the following Chemical Formulas may be used. LiaA1-bXbO2-cDc (0.90≤a≤1.8, 0≤b≤0.5, and 0≤c≤0.05); LiaMn2-bXbO4-cDc (0.90≤a≤1.8, 0≤b≤0.5, and 0≤c≤0.05); LiaNi1-b-cCobXcO2-αDα (0.90≤a≤1.8, 0≤b≤0.5 0≤c≤0.5, and 0<α<2); LiaNi1-b-cMnbXcO2-αDα (0.90≤a≤1.8, 0≤b≤0.5, 0≤c≤0.5, and 0<α<2); LiaNibCocL1dGeO2 (0.90≤a≤1.8, 0≤b≤0.9, 0≤c≤0.5, 0≤d≤0.5, and 0≤e≤0.1); LiaNiGbO2 (0.90≤a≤1.8 and 0.001≤b≤0.1); LiaCoGbO2 (0.90≤a≤1.8 and 0.001≤b≤0.1); LiaMn1-bGbO2 (0.90≤a≤1.8 and 0.001≤b≤0.1); LiaMn2GbO4 (0.90≤a≤1.8 and 0.001≤b≤0.1); LiaMn1-gGgPO4 (0.90≤a≤1.8 and 0≤g≤0.5); Li(3-f)Fe2(PO4)3 (0≤f≤2); or LiaFePO4 (0.90≤a≤1.8).

In the above Chemical Formulas, A is Ni, Co, Mn, or a combination thereof; X is Al, Ni, Co, Mn, Cr, Fe, Mg, Sr, V, a rare earth element or a combination thereof; D is O, F, S, P, or a combination thereof; G is Al, Cr, Mn, Fe, Mg, La, Ce, Sr, V, or a combination thereof; and L1 is Mn, Al, or a combination thereof.

The positive electrode active material may be, for example, a high nickel positive electrode active material having a nickel content of greater than or equal to about 80 mol %, greater than or equal to about 85 mol %, greater than or equal to about 90 mol %, greater than or equal to about 91 mol %, or greater than or equal to about 94 mol % and less than or equal to about 99 mol % based on 100 mol % of the metal excluding lithium in the lithium transition metal composite oxide. The high-nickel positive electrode active material may be capable of realizing high capacity and can be applied to a high-capacity, high-density rechargeable lithium battery.

According to an embodiment, when the electrode 100 is formed as a negative electrode, the mixture portion 116 may include a negative electrode active material.

The negative electrode active material may include a material that reversibly intercalates/deintercalates lithium ions, a lithium metal, a lithium metal alloy, a material capable of doping/dedoping lithium, or a transition metal oxide.

The material that reversibly intercalates/deintercalates lithium ions may include a carbon negative electrode active material, such as, for example. crystalline carbon, amorphous carbon or a combination thereof. The crystalline carbon may be graphite such as non-shaped, sheet-shaped, flake-shaped, sphere-shaped, or fiber-shaped natural graphite or artificial graphite. The amorphous carbon may be a soft carbon, a hard carbon, a mesophase pitch carbonization product, calcined coke, and the like.

The lithium metal alloy includes an alloy of lithium and a metal selected from Na, K, Rb, Cs, Fr, Be, Mg, Ca, Sr, Si, Sb, Pb, In, Zn, Ba, Ra, Ge, Al, and Sn.

The material capable of doping/dedoping lithium may be a Si negative electrode active material or a Sn negative electrode active material. The Si negative electrode active material may include silicon, a silicon-carbon composite, SiOx (0<x<2), a Si-Q alloy (where Q is selected from an alkali metal, an alkaline-earth metal, a Group 13 element, a Group 14 element (excluding Si), a Group 15 element, a Group 16 element, a transition metal, a rare earth element, and a combination thereof). The Sn negative electrode active material may include Sn, SnO2, a Sn alloy, or a combination thereof.

The silicon-carbon composite may be a composite of silicon and amorphous carbon. According to an embodiment, the silicon-carbon composite may be in a form of silicon particles and amorphous carbon coated on the surface of the silicon particles. For example, the silicon-carbon composite may include a secondary particle (core) in which primary silicon particles are assembled, and an amorphous carbon coating layer (shell) on the surface of the secondary particle. The amorphous carbon may also be between the primary silicon particles, and, for example, the primary silicon particles may be coated with the amorphous carbon. The secondary particle may exist dispersed in an amorphous carbon matrix.

The silicon-carbon composite may further include crystalline carbon. For example, the silicon-carbon composite may include a core including crystalline carbon and silicon particles and an amorphous carbon coating layer on a surface of the core.

The Si negative electrode active material or the Sn negative electrode active material may be used in combination with a carbon negative electrode active material.

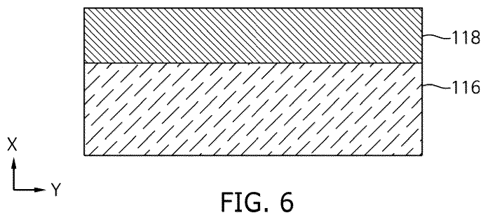

FIG. 6 is a plan view illustrating an upper part of the composite substrate cut along line X-X′ of FIG. 5, and FIG. 7 is a plan view illustrating an example of the composite substrate having the substrate tab welded thereon according to an embodiment of the present disclosure. Because the electrode 100 has a symmetrical structure along X-X′ line, for the sake of convenience in description, the following description focuses on the upper part of the composite substrate 110 (relative to the orientation of FIG. 5) cut along X-X′ line of FIG. 5.

Referring to FIGS. 6 and 7, the substrate tab 120 may be welded to a surface of the uncoated portion 118 of the composite substrate 110. The composite substrate 110 may include the welding portion 115 formed by welding with the substrate tab 120 (e.g., the welding portion 115 may be a portion of the substrate tab 120 directly welded with the uncoated portion 118 of the composite substrate 110).

According to an embodiment, the welding portion 115 may be formed by coupling a contact surface of the substrate tab 120 disposed on the uncoated portion 118 of the composite substrate 110 and the uncoated portion 118 of the composite substrate 110 by welding. For example, the welding portion 115 may be formed to extend in a longitudinal direction of the electrode.

According to an embodiment, the welding portion 115 may be formed at a position separated from the mixture portion 116 formed on the composite substrate 110, and may be formed to extend in the length direction of the electrode. For example, the welding portion 115 may be formed to be separated from the boundary line between the mixture portion 116 and the uncoated portion 118 by the predetermined distance b. When the boundary line between the mixture portion 116 and the uncoated portion 118 (see FIG. 7) and the welding portion 115 are formed to come into contact with each other, or when the separation distance b is less than a predetermined length, the active material of the mixture portion 116 may be deformed by heat applied to the welding portion 115. As the separation distance b between the welding portion 115 and the boundary line of the mixture portion 116 and the uncoated portion 118 increases, a width of the mixture portion 116 decreases. As a result, there may be a disadvantage in terms of battery capacity. Accordingly, in consideration of such a circumstance, the separation distance b between the welding portion 115 and the boundary line between the mixture portion 116 and the uncoated portion 118 may be set. The welding portion 115 may be formed at the predetermined distance a from the position separated from the mixture portion 116 by the predetermined distance b to the end of the composite substrate 110 (e.g., the welding portion 115 may be formed to have a width ‘a’ along the X-axis from the predetermined distance b toward the end of the composite substrate 110).

FIG. 8 is a sectional view illustrating an example of a composite substrate having a substrate tab welded thereto according to an embodiment of the present disclosure.

Referring to FIG. 8, the electrode 100 may include the composite substrate 110 including the first metal layer 112_1, the polymer layer 114, and the second metal layer 112_2 that are sequentially stacked. The electrode 100 may further include a first substrate tab 120a coupled with the first metal layer 112_1 and a second substrate tab 120b coupled with the second metal layer 112_2. For example, the first and second substrate tabs 120a and 120b may be coupled with the metal layers 112 by welding. The electrode 100 may include the mixture portion 116, formed by applying the active material to the surface of a composite substrate 110, and the uncoated portion 118 from which the surface of the composite substrate 110 is exposed. The electrode 100 may include sealing layers 130a and 130b, respectively, disposed between the composite substrate 110 and the first substrate tab 120a and between the composite substrate 110 and the second substrate tab 120b, respectively.

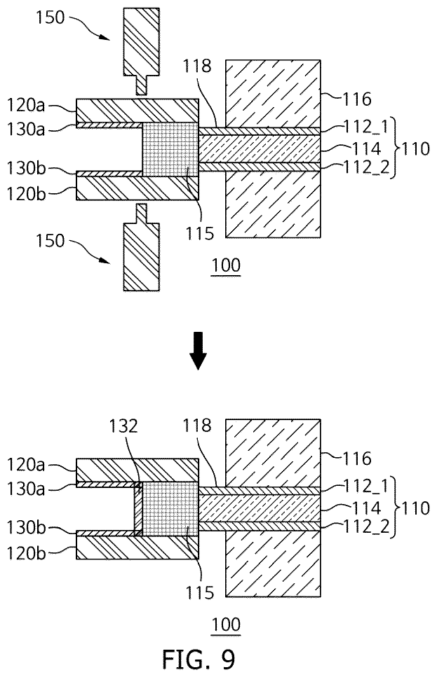

According to an embodiment, the sealing layers 130a and 130b may include the first sealing layer 130a formed on a surface of the first substrate tab 120a facing the first metal layer 112_1, and the second sealing layer 130b formed on a surface of the second substrate tab 120b facing the second metal layer 112_2. Accordingly, the first sealing layer 130a and the second sealing layer 130b may be disposed to face each other. As a result, the first sealing layer 130a and the second sealing layer 130b may be connected to each other by being melted by a sealer. Such a case will be described in detail with reference to FIG. 9.

According to an embodiment, the first substrate tab 120a, the composite substrate 110, and the second substrate tab 120b may be coupled with each other by the welding portion 115. The welding portion 115 may include the first metal layer 112a and the second metal layer 112b of the composite substrate 110. The first metal layer 112a and the second metal layer 112b of the welding portion 115 and the first substrate tab 120a and the second substrate tab 120b may be made of similar or identical metal materials and may be easily coupled by ultrasonic welding.

According to an embodiment, the welding portion 115 may be formed at a position separated from the mixture portion 116 formed in the composite substrate 110. The welding portion 115 may be formed to be separated from the boundary line between the mixture portion 116 and the uncoated portion 118 by the predetermined distance b.

According to an embodiment, the welding portion 115 may be formed at a corner portion of the first metal layer 112_1 and the second metal layer 112_2 (e.g., the welding portion 115 may overlap the corner portion of the first metal layer 112_1 and the second metal layer 112_2). For example, the welding portion 115 may be formed from the position separated from the mixture portion 116 by the predetermined distance b to the end of the composite substrate 110 (e.g., the welding portion 115 may extend from the position separated from the mixture portion 116 by the predetermined distance b to an outermost end of the composite substrate 110 that is overlapped by the substrate tab 120). The welding portion 115 may be formed at the predetermined distance a from the position separated from the mixture portion 116 by the predetermined distance b to the end of the composite substrate 110.

FIG. 9 is a diagram illustrating an example in which a substrate tab is sealed by using a sealer according to an embodiment of the present disclosure. The description of the configurations described in FIGS. 1 to 8 among configurations of FIG. 9 is omitted.

Referring to FIG. 9, the electrode 100 may include the fixing portion 132 formed by a sealing method. Among sealing methods, heat sealing may be a method for coupling multiple thermoplastic materials by using heat and pressure. Heat sealing may be performed by applying heat and pressure to an overlapping portion of multiple thermoplastic materials by using a sealer 150 to melt the materials, and then solidifying and sealing these materials when the heat is removed. The sealer 150 may include, e.g., a bar sealer, a rotary sealer, a vacuum sealer, and an induction sealer.

According to an embodiment, the sealing layers 130a and 130b may be melted to form the fixing portion 132 that fixes the first substrate tab 120a and the second substrate tab 120b. The sealing layers 130a and 130b may melt at a portion where heat and pressure are applied by the sealer 150. Even though heat and pressure are applied to surfaces on which the sealing layers 130a and 130b of the first substrate tab 120a and the second substrate tab 120b are not disposed by the sealer 150, the sealing layers 130a and 130b may be melted. The portion where heat and pressure are applied by the sealer 150 may be set in consideration of a position of the fixing portion 132 to be formed. For example, referring to FIG. 9, a portion of the sealing layers 130a and 130b adjacent to the welding portion 115 may be melted to form the fixing portion 132 along an outer surface of the welding portion 115 to connect (e.g., directly connect) between the sealing layers 130a and 130b.

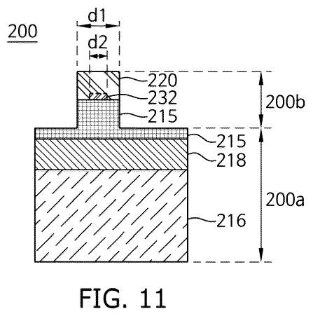

According to an embodiment, the fixing portion 132 may be formed by melting and connecting the sealing layer 130a disposed between the composite substrate 110 and the first substrate tab 120a and the sealing layer 130b disposed between the composite substrate 110 and the second substrate tab 120b. The fixing portion 132 may include a melted portion of each of the sealing layers 130a and 130b, and may be formed adjacent to the welding portion 115. Accordingly, additional fixing strength by the fixing portion 132 may be secured in addition to the fixing strength of the first substrate tab 120a and the second substrate tab 120b by welding. Due to these structural features, the fixing strength of the substrate tabs 120a and 120b is increased, and thus, uniformity of a cut surface is improved when the substrate tabs 120a and 120b are cut. As a result, quality of an electrode 200 (see FIG. 11) can be improved at the time of punching.

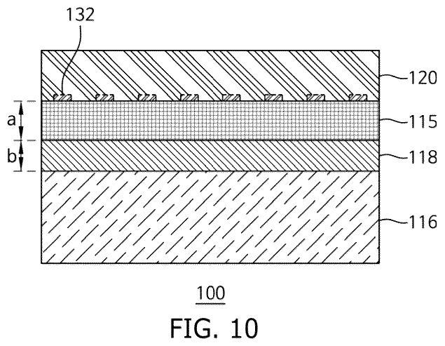

FIG. 10 is a plan view illustrating an example of the electrode 100 including the fixing portion 132 according to an embodiment of the present disclosure. FIG. 10 is a plan view illustrating the fixing portion 132 positioned inside the substrate tab 120 when the electrode of FIG. 9 is viewed from above. The description of the configurations described in FIGS. 1 to 9 among configurations of FIG. 10 is omitted.

Referring to FIG. 10, the fixing portion 132 may be formed on a lower side of the substrate tab 120 (i.e., in the orientation shown in FIG. 10). As a size of the fixing portion 132 increases, the fixing strength of the substrate tab 120 increases. However, the fixing portion 132 may be made of an insulating material to increase a resistance of the secondary battery. Accordingly, the size of the fixing portion 132 may be set in consideration of the fixing strength and the resistance of the secondary battery.

According to an embodiment, when heat and pressure are applied to only a part of the substrate tab 120 by using the sealer during the sealing process, the fixing portion 132 may be formed only on a part of the substrate tab 120. Accordingly, the fixing portion 132 may be formed only on a part of an area of the substrate tab 120 inside the substrate tab 120.

According to an embodiment, the fixing portion 132 may be adjacent to the welding portion 115 and may be disposed at a predetermined interval in a longitudinal direction of the substrate tab 120. As a result, additional fixing strength may be secured by the fixing portion 132, and the size of the fixing portion 132 may be reduced to prevent the increase in the resistance of the secondary battery. Additionally, the substrate tab may be cut to include the fixing portion 132 at the time of punching.

FIG. 11 is a plan view illustrating an example of a punched electrode according to an embodiment of the present disclosure. The description of the configurations described in FIGS. 1 to 10 among the configurations of FIG. 11 is omitted.

Referring to FIG. 11, an electrode 200 may include a body portion 200a including a mixture portion 216, an uncoated portion 218, and a first portion of the welding portion 215, and a tab portion 200b protruding from the body portion 200a and including a second portion of the welding portion 215 and a fixing portion 232. For example, referring to FIG. 11, the first and second portions of the welding portion 215 may be different from each other(e.g., may have different widths).

According to an embodiment, a width d2 of the fixing portion 232 may be smaller than a width d1 of the tab portion 200b. A length of the fixing portion 232 may be shorter than a length of the tab portion 200b with respect to a direction in which the tab portion 200b protrudes. The length of the fixing portion 232 may be about 1 mm with respect to the direction in which the tab portion 200b protrudes.

According to an embodiment, the width d2 of the fixing portion 232 may be 40% to 60% of the width d1 of the tab portion 200b. As a result, the increase in the resistance of the secondary battery may be prevented. However, the width d2 of the fixing portion 232 may vary, and the width d2 of the fixing portion 232 may be set in various manners in consideration of the fixing strength and the increase in the resistance of the secondary battery.

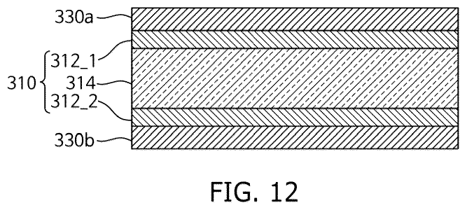

FIG. 12 is a sectional view illustrating an example of a composite substrate including a sealing layer according to an embodiment of the present disclosure. The description of the configurations of the composite substrate described in FIG. 2 is omitted.

Referring to FIG. 12, sealing layers 330a and 330b may include a third sealing layer 330a formed on a first metal layer 312_1 and a fourth sealing layer 330b formed on a second metal layer 312_2.

A thickness of the sealing layers 330a and 330b may be set in consideration of the sealing strength. As the thickness of the sealing layers 330a and 330b increases, the sealing strength may increase. However, the energy density of the secondary battery decreases, and thus, it may appropriately set the thickness of the sealing layer.

According to an embodiment, the thickness of the sealing layers 330a and 330b may be set to 1 μm to 5 μm to secure sufficient sealing strength of 1 kgf or more. As a result, appropriate sealing strength may be secured, and the energy density of the secondary battery may be prevented from decreasing. In the secondary battery, the energy density may mean the amount of energy that may be stored per unit volume.

According to an embodiment, the material of the sealing layers 330a and 330b may contain any one of cast polypropylene (CPP) and polypropylene (PP). Cast polypropylene (CPP) and polypropylene (PP) are materials based on polymer substances and have high thermoplasticity, cast polypropylene (CPP) and polypropylene (PP) may be melted and sealed by a sealer. Solidified cast polypropylene (CPP) and polypropylene (PP) may increase the fixing strength of the substrate tab 120 due to excellent mechanical properties. However, the material of the sealing layers 330a and 330b may vary.

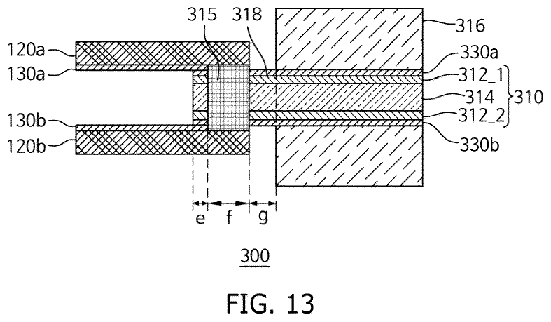

FIG. 13 is a sectional view illustrating an example of a composite substrate having a substrate tab welded thereto according to an embodiment of the present disclosure. The description of the configurations described in FIG. 8 among the configurations of FIG. 13 is omitted.

Referring to FIG. 13, an electrode 300 may include a first sealing layer 130a, a second sealing layer 130b, a third sealing layer 330a, and a fourth sealing layer 330b.

According to an embodiment, the third sealing layer 330a may come into contact (e.g., direct contact) with the first sealing layer 130a, and the fourth sealing layer 330b may come into contact (e.g., direct contact) with the second sealing layer 130b. As a result, the third sealing layer 330a and the first sealing layer 130a may be melted and connected by using a sealer, and the fourth sealing layer 330b and the second sealing layer 130b can be melted and connected by using a sealer.

According to an embodiment, the first substrate tab 120a, a composite substrate 310, and the second substrate tab 120b may be coupled with each other by a welding portion 315.

According to an embodiment, the welding portion 315 may be formed at a position separated from a mixture portion 316 formed on the composite substrate 310 and may be formed to extend in the longitudinal direction of the electrode. The welding portion 315 may be formed to be separated from a boundary line between the mixture portion 316 and an uncoated portion 318 at a predetermined distance g.

According to an embodiment, the welding portion 315 may be formed separated from corner portions of the first metal layer 312_1 and the second metal layer 312_2.

For example, the welding portion 315 may be formed to be separated from the corner portions of the first metal layer 312_1 and the second metal layer 312_2 at a predetermined distance e. Accordingly, the welding portion 315 may be formed at a predetermined distance f (e.g., to have a length equal to the predetermined distance f).

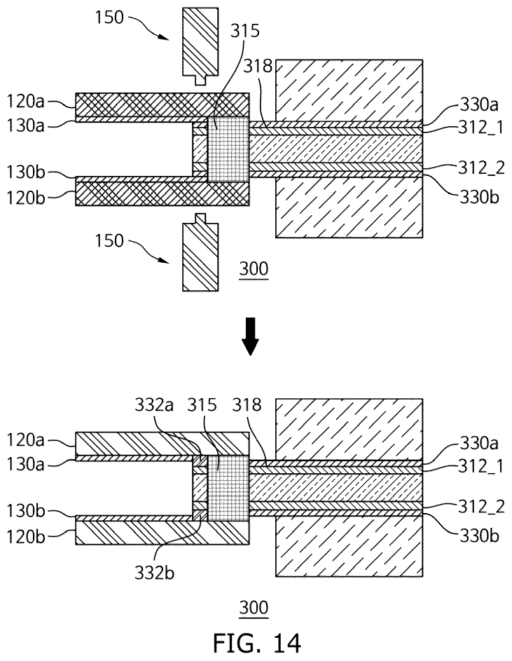

FIG. 14 is a diagram illustrating an example in which the substrate tab and the composite substrate by using the sealer according to an embodiment of the present disclosure. The description of the configurations described in FIG. 9 among the configurations of FIG. 14 is omitted.

According to an embodiment, the sealing layers 130 and 330 may be melted to form first and second fixing portions 332a and 332b that fix the first substrate tab 120a and the second substrate tab 120b.

According to an embodiment, the first and second fixing portions 332a and 332b may be formed separately by melting the sealing layers 130a and 330a disposed between the composite substrate 310 and the first substrate tab 120a, and the sealing layers 130b and 330b disposed between the composite substrate 310 and the second substrate tab 120b, respectively. As such, referring to FIG. 14, the first and second fixing portions 332a and 332b may be separated (e.g., spaced apart) from each other.

In the embodiment of FIG. 14, compared to the embodiment of FIG. 9, a distance between the sealing layers 130 and 330 is reduced, and thus, a contact area increases. As a result, sealing quality may be improved. As a result, the fixing strength between the substrate tab 120 of the fixing portion 332a and 332b and the first and second metal layers 312_1 and 312_2 may be further increased. As the distance between the sealing layers 130 and 330 is reduced, positions of the fixing portions 332a and 332b at the time of sealing may be prevented from being dispersed.

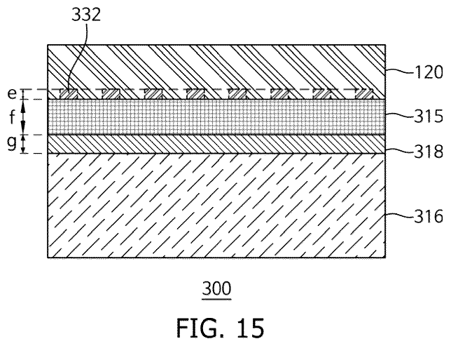

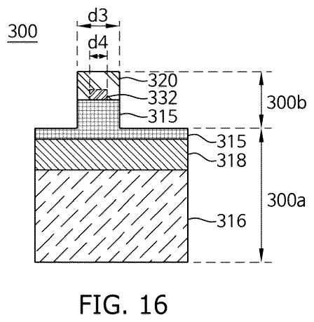

FIG. 15 is a plan view illustrating an example of the electrode including the fixing portion according to an embodiment of the present disclosure, and FIG. 16 is a plan view illustrating an example of the electrode according to an embodiment of the present disclosure. FIG. 15 is a plan view illustrating a fixing portion 332 positioned inside the substrate tab 120 when the electrode of FIG. 14 is viewed from above. The description of the configurations described in FIGS. 12 to 14 among configurations of FIGS. 15 and 16 is omitted.

Referring to FIG. 15, the fixing portion 332 may be formed inside the substrate tab 120. As a size of the fixing portion 332 increases, the fixing strength of the substrate tab 120 increases. However, the fixing portion 332 may be made of an insulating material to increase the resistance of the secondary battery. Accordingly, the size of the fixing portion 332 may be set in consideration of the fixing strength and the resistance of the secondary battery.

According to an embodiment, when heat and pressure are applied to only a part of the substrate tab 120 by using the sealer during the sealing process, the fixing portion 332 may be formed only on a part of the substrate tab 120. Accordingly, the fixing portion 332 may be formed only on a part of an area of the substrate tab 120 inside the substrate tab 120.

According to an embodiment, the fixing portion 332 may be adjacent to the welding portion 315 and may be disposed at a predetermined interval in the longitudinal direction of the substrate tab 120. As a result, additional fixing strength can be secured by the fixing portion 332, and the size of the fixing portion 332 can be reduced to prevent the increase in the resistance of the secondary battery. Additionally, the substrate tab may be cut to include the fixing portion 332 at the time of punching.

Referring to FIG. 16, the electrode 300 may include a body portion 300a including the mixture portion 316, the uncoated portion 318, and the welding portion 315, and a tab portion 300b protruding from the body portion 300a and including the welding portion 315 and the fixing portion 332.

According to an embodiment, a width d4 of the fixing portion 332 may be smaller than a width d3 of the tab portion 300b. A length of the fixing portion 332 may be shorter than a length of the tab portion 300b with respect to a direction in which the tab portion 300b protrudes. The length of the fixing portion 332 may be about 1 mm with respect to the direction in which the tab portion 300b protrudes.

According to an embodiment, the width d4 of the fixing portion 332 may be 40% to 60% of the width d3 of the tab portion 300b. As a result, the increase in the resistance of the secondary battery can be prevented. However, the width d4 of the fixing portion 332 is may vary, and the width d4 of the fixing portion 332 may be set in various manners in consideration of the fixing strength and the increase in the resistance of the secondary battery.

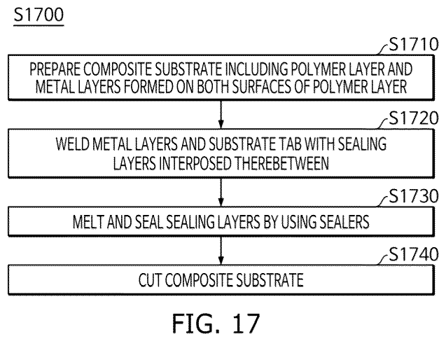

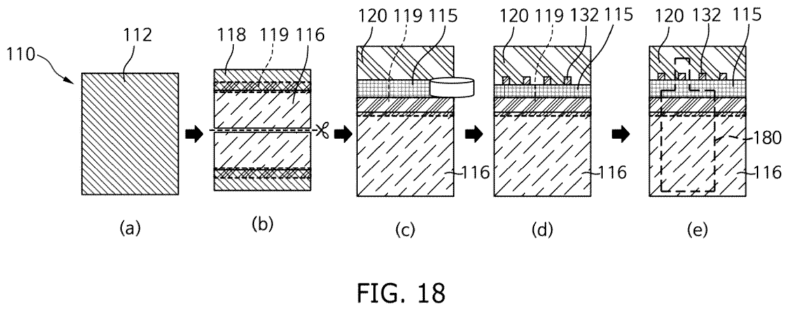

FIG. 17 is a flowchart illustrating a method for manufacturing an electrode according to an embodiment of the present disclosure, and FIG. 18 is a diagram for describing stages in the method for manufacturing an electrode according to an embodiment of the present disclosure.

Referring to FIG. 17 and part (a) of FIG. 18, an electrode manufacturing method S1700 may be initiated by preparing the composite substrate 110 including the polymer layer and the metal layers 112 formed on both surfaces of the polymer layer (S1710).

In an embodiment, the composite substrate 110 may include the first metal layer, the polymer layer, and the second metal layer that are sequentially stacked. The composite substrate 110 may include a surface processing layer and an adhesive layer between the metal layer 112 and the polymer layer. In an embodiment, each of the first metal layer and the second metal layer may be coated with a metal material such as copper (Cu), a copper alloy, nickel (Ni), or a nickel alloy on the polymer layer, or may be coated with a metal material such as aluminum (Al) or an aluminum alloy. The first metal layer 112_1 and the second metal layer 112_2 may be made of an identical metal material and may function as a positive electrode or a negative electrode. In an embodiment, the polymer layer may contain a polymer material. For example, the polymer layer 114 may contain a polyethylene terephthalate (PET) resin. The material of the polymer layer 114 may include, e.g., a polyester resin such as polytrimethylene terephthalate (PTT), polybutylene terephthalate (PBT), or polyethylene naphthalate (PEN).

As illustrated in part (a) of FIG. 18, the composite substrate 110 may be prepared such that the metal layer 112 faces the outside.

As illustrated in part (b) of FIG. 18, the composite substrate 110 may be cut along the longitudinal direction of the composite substrate.

Subsequently, as illustrated in part (c) of FIG. 18, the metal layer 112 and the substrate tab 120 may be welded with the sealing layer interposed therebetween (S1720). In an embodiment, welding the metal layer 112 and the substrate tab 120 with the sealing layer interposed therebetween may include disposing the substrate tab 120 on the metal layer 112 with the sealing layer interposed therebetween, and welding the metal layer 112 and the substrate tab 120 by using a welding horn. In an embodiment, the welding horn may rotate at 10 mm/s to 100 mm/s, and the process may be performed by pressurizing the metal layer 112 and the substrate tab 120 at 0.1 MPa to 0.5 MPa.

In an embodiment, the welding portion 115 may be formed by coupling the contact surface of the substrate tab 120 disposed on the uncoated portion 118 of the composite substrate 110 and the uncoated portion 118 of the composite substrate 110 by welding. In an embodiment, the welding portion 115 may be formed at the position separated from the mixture portion 116 formed on the composite substrate 110 and may be formed to extend in the length direction of the electrode. In an embodiment, the welding portion 115 may be formed at the corner portion of the metal layer 112. In an embodiment, the insulating layer 119 may be formed at a portion where the welding portion 115 and the mixture portion 116 are separated from each other.

Thereafter, as illustrated in part (d) of FIG. 18, the sealing layer may be melted and sealed by using the sealer (S1730). In an embodiment, melting and sealing the sealing layer by using the sealer may include melting the sealing layer to form the fixing portion 132 that fixes the substrate tab. In an embodiment, the fixing portion 132 may be disposed to be separated along the length direction of the welding portion 115. In an embodiment, a temperature of the sealer may be 155° C. or higher and the sealing process may be performed for 1 second to 3 seconds.

Finally, as illustrated in part (e) of FIG. 18, the composite substrate 110 may be cut (S1740). In an embodiment, cutting the composite substrate 110 may include punching to include the fixing portion 132. In an embodiment, the composite substrate 110 may be cut along a punch line 180.

The flowchart and the above description of FIGS. 17 and 18 are merely examples of the present disclosure, and the scope of the present disclosure may vary. For example, one or more steps in the flowchart and/or the above description may be added, changed, and/or deleted, the order of one or more steps may be changed, and one or more steps may be simultaneously performed.

By way of summation and review, electronic devices and/or automobiles provide various functions and/or various services incorporated therein. For example, a composite substrate including an insulating substrate and metal substrates on both surfaces thereof as a metal substrate of an electrode included in a secondary may be used, and the composite substrate may contribute to a weight reduction of the secondary battery in terms of replacing a part of a whole metal substrate with a portion including the insulating substrate.

However, due to the insulating properties of the composite substrate, the metal substrates with the insulating substrate interposed therebetween may not be electrically connected. While separate substrate tabs may be welded to the metal substrates of the composite substrate, and may be electrically connected to an outside through the substrate tabs, the fixing strength of the substrate tabs welded to the composite substrate may be insufficient.

In contrast, the present disclosure provides an electrode and a method for manufacturing an electrode.

According to some embodiments of the present disclosure, the electrode and the method for manufacturing an electrode having improved fixing strength of the substrate tab can be provided.

According to some embodiments of the present disclosure, the uniformity of the cut surface of the substrate tab can be increased when the substrate tab is cut by sealing the welded substrate tab to increase the fixing strength.

According to some embodiments of the present disclosure, the deformation of the substrate tab at the time of punching the electrode can be prevented to improve the quality of the electrode by sealing the welded substrate tab to increase the fixing strength.

However, aspects and features of the present disclosure are not limited to those described above, and other aspects and features not mentioned will be clearly understood by a person skilled in the art from the detailed description, described above.

Although the present disclosure has been described above with respect to embodiments thereof, the present disclosure is not limited thereto. Various modifications and variations can be made thereto by those skilled in the art within the spirit of the present disclosure and the equivalent scope of the appended claims.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated.

Accordingly, it will be understood by those of skill in the art that various changes in form and details may be made without departing from the spirit and scope of the present invention as set forth in the following claims.

What is claimed is:

1. An electrode, comprising:
a composite substrate including a first metal layer, a polymer layer, and a second metal layer, which are sequentially stacked;
a first substrate tab coupled with the first metal layer;
a second substrate tab coupled with the second metal layer; and
a sealing layer between the composite substrate and each of the first substrate tab and the second substrate tab.

2. The electrode as claimed in claim 1, wherein the sealing layer includes:
a first sealing layer on a surface of the first substrate tab facing the first metal layer; and
a second sealing layer on a surface of the second substrate tab facing the second metal layer.

3. The electrode as claimed in claim 2, wherein the sealing layer further include a third sealing layer on the first metal layer and a fourth sealing layer on the second metal layer.

4. The electrode as claimed in claim 3, wherein the third sealing layer is in contact with the first sealing layer, and the fourth sealing layer is in contact with the second sealing layer.

5. The electrode as claimed in claim 2, wherein a thickness of each of the first sealing layer and the second sealing layer is 1 μm to 5 μm.

6. The electrode as claimed in claim 2, wherein each of the first sealing layer and the second sealing layer includes at least one of cast polypropylene or polypropylene.

7. The electrode as claimed in claim 1, wherein:
the first substrate tab is welded to the first metal layer,
the second substrate tab is welded to the second metal layer, and
the first substrate tab, the composite substrate, and the second substrate tab are coupled with each other by a welding portion.

8. The electrode as claimed in claim 7, wherein:
the composite substrate includes a mixture portion on each of the first metal layer and the second metal layer, and
the welding portion is at a position separated from the mixture portion, the welding portion extending in a longitudinal direction of the electrode.

9. The electrode as claimed in claim 8, wherein the welding portion is at corner portions of the first metal layer and the second metal layer.

10. The electrode as claimed in claim 8, wherein the welding portion is separated from corner portions of the first metal layer and the second metal layer.

11. The electrode as claimed in claim 7, further comprising a fixing portion that fixes the first substrate tab and the second substrate tab, the fixing portion including a melted portion of the sealing layer.

12. The electrode as claimed in claim 11, wherein the fixing portion includes a melted portion of the sealing layer between the composite substrate and each of the first substrate tab and the second substrate tab.

13. The electrode as claimed in claim 11, wherein the fixing portion includes:
a first fixing portion having a melted portion of the sealing layer between the composite substrate and the first substrate tab; and
a second fixing portion having a melted portion of the sealing layer between the composite substrate and the second substrate tab, the first fixing portion and the second fixing portion being separated from each other.

14. The electrode as claimed in claim 11, further comprising:
a body portion including a mixture portion, an uncoated portion, and a first portion of the welding portion; and
a tab portion protruding from the body portion, the tab portion including a second portion of the welding portion and the fixing portion.

15. The electrode as claimed in claim 14, wherein a width of the fixing portion is smaller than a width of the tab portion.

16. The electrode as claimed in claim 15, wherein the width of the fixing portion is 40% to 60% of the width of the tab portion.

17. A method for manufacturing an electrode, the method comprising:
preparing a composite substrate including a first metal layer, a polymer layer, and a second metal layer, which are sequentially stacked;
welding the first metal layer to a first substrate tab and the second metal layer to a second substrate tab with a sealing layer, the sealing layer being between the composite substrate and each of the first substrate tab and the second substrate tab;
melting and sealing the sealing layer by using a sealer; and
cutting the composite substrate.

18. The method as claimed in claim 17, wherein welding the first metal layer and the second metal layer includes:
disposing the first substrate tab and the second substrate tab on the first metal layer and the second metal layer, respectively, with the sealing layer interposed therebetween; and
welding the first metal layer and the second metal layer to the first substrate tab and the second substrate tab by using a welding horn.

19. The method as claimed in claim 18, wherein the melting and sealing of the sealing layer includes melting the sealing layer to form a fixing portion that fixes the first substrate tab and the second substrate tabs, such that the fixing portion is disposed to be separated along a longitudinal direction of a welding portion.

20. The method as claimed in claim 19, wherein the cutting includes punching so as to include the fixing portion.
